(19) United States
(12) Patent Application Publication
(10) Pub. No.: US 2011/0239400 A1
(43) Pub. Date: Oct. 6, 2011

(54) Sliding Door

(75) Inventors: Thomas Vogler, Bad Salzuflen (DE); Jörg Sunderbrink, Bad Oeynhausen (DE); Wilfried Kletscher, Bad Salzuflen (DE); Oliver Walhorn, Werther (DE); Ralf Kreyenbrog, Bad Salzuflen (DE)

(73) Assignee: Dorma GmbH + Co. KG, Ennepetal (DE)

(21) Appl. No.: 13/139,498

(22) PCT Filed: Dec. 7, 2009
(86) PCT No.: PCT/EP2009/008708

§ 371 Date: Jun. 13, 2011

(30) Foreign Application Priority Data
Dec. 12, 2008 (DE) 10 2008 061 728.8

(51) Int. Cl. E05F 3/00; E05D 15/06

(52) U.S. Cl. 16/65; 16/49

(57) ABSTRACT

A sliding door with a door leaf, which is suspended from at least one carriage and is guided to be displaceable along a roller rail profile, which is disposed at a wall or at a ceiling. The sliding door having a closing device, suitable to displace the door leaf into a closed position in a decelerated manner. The closing device includes at least one spring-damper element disposed near a ground level area at the door leaf by a carrier module.

### PRIORITY CLAIM

This is a U.S. national stage of Application No. PCT/EP2009/008708, filed on Dec. 7, 2009, which claims priority to German Application No: 10 2008 061 728.8, filed: Dec. 12, 2008, the contents of which are incorporated herein by reference.

### BACKGROUND OF THE INVENTION

1. Field of the Invention

The present invention relates to a sliding door with a door leaf suspended from at least one carriage guided to be displaceable along a roller rail profile disposed at a wall or at a ceiling, the sliding door having a closing device suitable to displace the door leaf into a closed position in a decelerated manner.

2. Related Art

The problem with sliding doors is that very often the doors, when being carelessly opened or closed impact on a limit stop; this can be very loud, but can also destroy a door, such as a glass sliding door. If the sliding door is closed with too much momentum, it will often bounce against the limit stop, which can only absorb a portion of the energy, such that the sliding door bounces back and remains in a not completely closed position. Closing devices are known for this purpose, which displace the sliding door into a terminal position and simultaneously achieve a damping effect.

When opening a sliding door with too much momentum, this results very often in the problem that the first user is able to easily pass the sliding door, after having triggered the opening operation, but the sliding door simultaneously returns into the partially closed position and the following user of the sliding door bumps with his shoulder or side into the sliding door; whereby, on the one hand, a risk of injury is given and, on the other hand, the sliding door will start to swing perpendicularly to the opening direction and thus may be prone to damage.

### SUMMARY OF THE INVENTION

It is an object of the invention to provide a sliding door in which the closing device effects a displacement into a terminal position and simultaneously a damping effect. In this case, the closing device should be as compact as possible and should be retrofittable to existing sliding doors.

One embodiment of the invention is characterized in that the closing device has at least one spring-damper element disposed near the ground level area at the door leaf by a carrier module. Thus a visually appealing and compact solution is achieved, which can be retrofitted to existing sliding doors. In this case, the closing device is mounted to the door leaf, essentially flush with the lower frontal edge, such as to give the impression it is a component of a lower terminating profile.

Disposing the closing device at the door leaf, near the ground level area, results in the closing device moving along with the door leaf and not having to absorb any static loads.

An advantageous embodiment of the invention is achieved, if the closing device has a second carrier module with another spring-damper element suitable to displace the door leaf in a decelerated manner into an open position. Via the carrier modules, the closing device may be equipped optionally with pre-mounted spring-damper elements for the open position and/or the closed position. Thereby, depending on the customer need, the closing devices can be equipped in a flexible and variable manner.

In one embodiment, the carrier module has a reversing lever, the latching nose thereof cooperating with a release. The reversing lever allows for an operative connection of the spring-damper element to the release. Depending on the configuration of the reversing lever, in this case, the release may be placed far away from the passage area of the door, such as not to interfere and not to represent a tripping hazard for the user of the door.

In a preferred embodiment, the reversing lever cooperates with the spring-damper element via a coupling member. In this case, the coupling member may simultaneously establish an operative connection with the reversing lever between one or more spring-damper elements disposed within the carrier module.

In one embodiment, the at least one carrier module is disposed at the door leaf via a profile. The connection via the profile allows for a variable attachment to the door leaf, because the profile is bonded, screwed onto the door leaf, or attached to it in a clamping manner. In this case, the profile may be configured as if it were a part of a lower frame, which comprises for example a glass pane.

Another simplified attachment of the carrier modules is achieved in that the profile has at least one track, which allows for a variable horizontal arrangement of the carrier module. According to one embodiment, two tracks allow for sliding the carrier modules in, which—depending on the reversing lever and release—may be aligned variably in horizontal direction and then be attached stationarily to the sliding door, respectively to the profile. The horizontal displaceability along the track allows for a very simple, yet precise installation of the closing device.

The carrier module may have a reception, at or in which the spring-damper elements are disposed. The reception may be configured in the shape of a box, and, after mounting the spring-damper elements, be closed by a cover such that soiling or even subsequent manipulation are avoided. It is furthermore possible to stock pre-mounted structural units for the open position or closed position, which are very easy to install.

### BRIEF DESCRIPTION OF DRAWINGS

Hereinafter, further measures enhancing the invention will be illustrated in detail in conjunction with the description of one preferred embodiment of the invention based on the Figures, in which:

FIG. 1: is an illustration of the entire door leaf with the closing device;

FIG. 2: is a detailed view of a carrier module with the cover being removed; and

FIG. 3: is a perspective illustration of a spring-damper element.

### DETAILED DESCRIPTION OF THE DRAWINGS

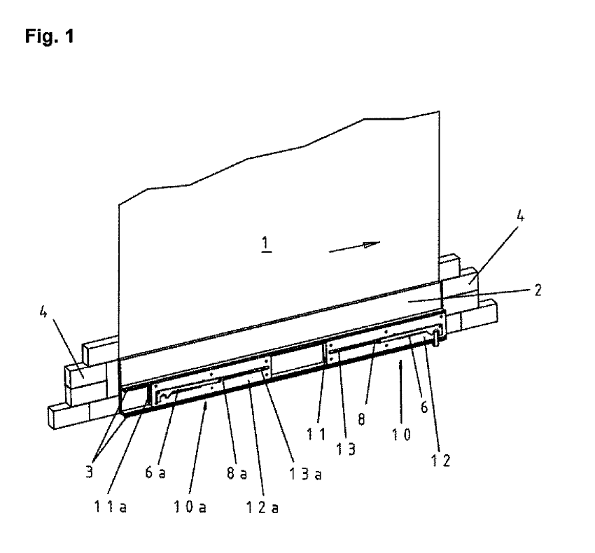

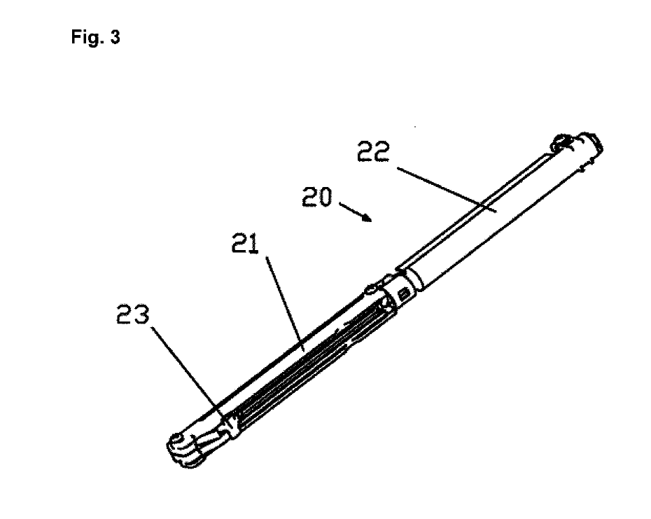

FIG. 1 illustrates the lower part of the inventive sliding door, which includes of a door leaf 1, including a non-illustrated carriage, and is guided to be displaceable in a roller rail profile at a wall 4 or at a ceiling. The door leaf 1 may be of glass, wood, or another optional material. Near a lower ground level area of the door leaf 1, a closing device is attached to the door leaf by a profile 2. This may be realized via bonding, clamping, or by a screw connection. In this case, the closing device includes at least one carrier module 10, 10a at which or in which at least one spring-damper element 20 is disposed (FIG. 3). One or two tracks 3, which accommodate one or two carrier modules 10, 10a, are disposed at the profile 2. In this embodiment, two carrier modules 10, 10a are inserted between two tracks 3 and attached by fasteners. Respectively one or two spring-damper elements 20 are disposed within the carrier modules 10, 10a. The disposition of the one or more carrier modules 10, 10a at or within a track 3 allows for variably positioning the spring-damper elements 20 at the door leaf 1, in that the closing position and the damping can be adjusted by horizontally displacing the carrier modules 10, 10a at or within the track 3. Each carrier module 10, 10a has a reception 11, 11a, which may be box-shaped and in which or at which one or two spring-damper elements 20 may be disposed. Each reception 11, 11a is closed off by a cover 12, 12a, which has an elongate slot 13, 13a in the direction of movement of the door leaf 1. One end of a reversing lever 6, 6a is connected to the spring-damper element 20 by a coupling member 8, 8a. In this case, the connection or attachment of the reversing lever 6, 6a to the coupling member 8, 8a passes through the slot 13, 13a of the cover 12,12a such that, in this embodiment, the reversing lever 6, 6a is disposed outside the reception 11, 11a. At another end, the reversing lever 6, 6a has a latching nose 7, 7a, which cooperates with a release 5. On the rear side, in the area of the latching nose 7, 7a, the reversing lever 6, 6a has a nose, bolt or guide, which is guided within the slot 13, 13a.

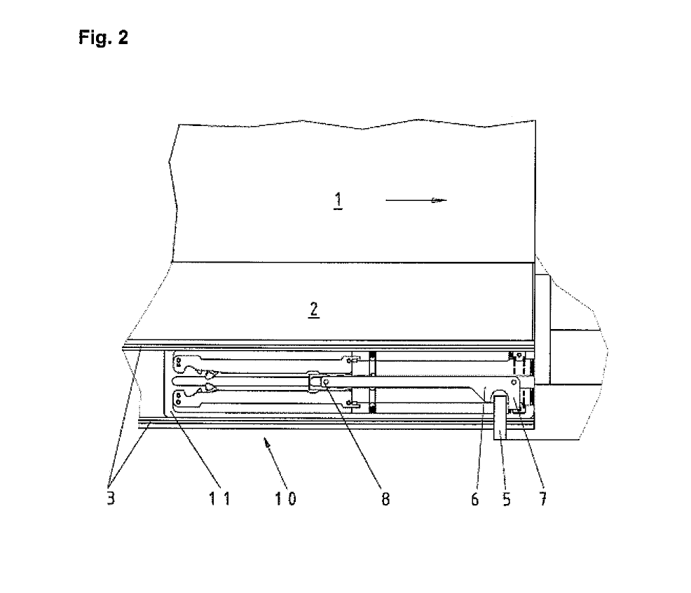

The carrier module 10 assists in and dampens the closing operation of the door leaf 1, wherein the spring 21 is compressed by the opening movement. If the door leaf 1 is moved into the opening direction (direction of arrow in FIGS. 1 and 2), initially the release 5 and the latching nose 7 of the reversing lever 6 are connected to each other. This movement compresses the spring 21 of the spring-damper element 20, because the reversing lever 6 is articulately connected to the coupling member 8. Once the spring 21 is compressed by the movement of the door leaf 1, the reversing lever 6 is separated from the release 5. This separation is effected by an upwards movement of the reversing lever 6, which is generated by a nose, bolt, or guide in a guide contour of a guide, coulisse, or within the slot 13.

If the door is moved in the closing direction (opposite to the direction of the arrow in FIG. 1), the latching nose 7 of the reversing lever 6 latches in the release 5 and—depending on the speed of the movement of the door—the deceleration of the door is realized by the damper 22. The spring 21 relaxes at the same time and thereby pushes the door leaf 1 into the terminal position of the closed position. If the closing device is equipped with a second carrier module 10a, the above described operation takes place in the reversed order. In this case, the spring 21 is compressed by the closing operation and moves the door leaf 1 into the terminal position of the open position, wherein the damper 22 decelerates the door leaf 1 at the same time. For this purpose, the spring-damper element 20 of the carrier module 10a is disposed to be counter-directional to the spring-damper element 20 of the carrier module 10.

Depending on the weight of the door leaf 1, up to two spring-damper elements 20 may be disposed in each carrier module 10, 10a.

In FIG. 3, a spring-damper element 20 is illustrated, which includes a spring 21, a damper 22 and a catch 23. Usually a compression spring is utilized as the spring 21, which takes a piston rod that protrudes from the damper 22, into a maximum extended position, in which the spring 21 is relaxed. The spring 21 is maintained in a compressed position, in a so-called parking position, until—by displacing the door leaf 1—the spring 1 is released and relaxes. When relaxing the spring 21 pushes, respectively accelerates the door leaf 1 into an open or closed position. The acceleration force acts against a deceleration force of the damper 22, which slows the door leaf 1 down, and thus the door leaf moves silently and shock-free into an open or closed position.

The damper 22 may be configured as a pneumatic or hydraulic damper, which has a piston disposed at a piston rod and is displaceably disposed within a cylinder. In this case, the damping action may be achieved in an upper and/or lower terminal position of the piston, in that a liquid or gaseous medium is compressed and/or displaced by the piston.

In order to achieve a closing function and a damping function in both directions of movement of the door leaf 1, the spring-damper elements 20 are disposed to be counter-directional in or at the carrier modules 10, 10a. A distinct release 5 is stationarily disposed near the floor for each spring-damper element 20.

Disposing the closing device on the door leaf 1 allows for retrofitting existing sliding doors without having to install new profiles, which otherwise would result in touching up or renovating the ceiling or wall cladding. In comparison to known stationary closing devices, which are disposed in the wall profile or ceiling profile or in depressions of the floor, the inventive closing device moves along with the door leaf 1. The profile 2 may be kept in stock by the meter and cut according to the width of the door leaf 1. The carrier modules 10, 10a are kept pre-mounted in the warehouse and corresponding to the function (damping for opening or closing) they are quickly installed fast. Another advantage of one embodiment of the invention is that the above described closing device does not have to absorb any static loads resulting from the weight of the leaves. Only the briefly occurring acceleration and deceleration forces need to be absorbed.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A sliding door with a door leaf suspended from at least one carriage guided to be displaceable along a roller rail profile disposed at one of a wall and a ceiling, the sliding door comprising:
a closing device configured to displace the door leaf into the closed position in a decelerated manner, the closing device having a first spring-damper element; and
a carrier module is disposed near a ground level area at the door leaf by which the closing device is affixed to the door leaf.

10. The sliding door according to claim 9, wherein the closing device comprises a second carrier module with a second spring-damper element configured to displace the door leaf into an open position in a decelerated manner.

11. The sliding door according to claim 9, wherein the carrier module comprises a reversing lever having a latching nose configured to cooperate with a release.

12. The sliding door according to claim 11, wherein the reversing lever cooperates with the spring-damper element via a coupling member.

13. The sliding door according to claim 9, wherein the at least one carrier module is disposed at the door leaf via a profile.

14. The sliding door according to claim 12, wherein the profile is attached to the door leaf by one or more of bonding, screwing, and clamping.

15. The sliding door according to claim 12, wherein the profile compriseses at least one track, configured for a variable horizontal disposition of the carrier module.

16. The sliding door according to claim 9, wherein the carrier module includes a reception at which the spring-damper elements are disposed.

17. The sliding door according to claim 10, wherein the carrier module comprises a reversing lever having a latching nose configured to cooperate with a release.
